(19) United States
(12) Patent Application Publication
(10) Pub. No.: US 2004/0083093 A1
(43) Pub. Date: Apr. 29, 2004

(54) Method of measuring nasality by means of a frequency ratio

(76) Inventors: Guo-She Lee, Hualien City (TW); Terry B. J. Kuo, Hualien Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/280,877

(22) Filed: Oct. 25, 2002

(51) Int. Cl. G10L 11/04

(52) U.S. Cl. 704/206

(57) ABSTRACT

A method for measuring nasality senses a sound, amplifies the sensed sound signal, converts the sound signal to a digital sound signal, transforms the digital time domain sound signal to a frequency domain with a Fast Fourier Transformation (FFT), determines a cut frequency (f_{cut}) calculates a low frequency power and a high frequency power of each window, calculates an acoustic low/high ratio (ALHR) and calculates an average acoustic low/high ratio (ALHRₐᵥₑ). With such a method, the ALHRₐᵥₑ reflects a person's nasality and nasal airway status, and the method is conveniently performed.

### BACKGROUND OF THE INVENTION

1. Field of the Invention

The present invention relates to a method of measure nasality and nasal airway, and more particularly to a method of measuring nasality by means of a ratio derived power spectrum analysis.

2. Description of Related Art

A conventional method of measuring a person's nasality uses two microphones to respectively measure the sound pressure sent out from the oral cavity and the nasal cavity. A ratio of the sound pressure of the nasal cavity to the sum of the sound pressure of the oral cavity and the nasal cavity is defined as nasalance. The nasalance can be an index for determining the nasality of a person with a carniofacial anomaly such as a cleft palate. However, the conventional measuring method uses a helmet with two microphones worn on the test subject's head, which makes the conventional measuring method inconvenient. Furthermore, the analysis of the nasality is not only dependent on the sound pressure, but also dependent on the frequency spectrum of the sound. The convention method is not adequate for accurately analyzing a person's nasality.

To overcome the shortcomings, the present invention provides a method for measuring the nasality, which mitigates or obviates the aforementioned problems.

### SUMMARY OF THE INVENTION

The main objective of the invention is to provide a method for measuring nasality that is convenient to be performed. The method senses a sound signal, amplifies the sensed sound signal, converts the sound signal to a digital sound signal, transforms the digital signal from time domain frequency domain by the algorithm of Fast Fourier Transformation (FFT), determine a cut frequency (f_{cut}) to divide the sound power spectrum into a low frequency band and a high frequency band, means for calculating low frequency power (LFP) and high frequency power (HFP) in each window, means for calculating an acoustic low/high ratio (ALHR) in each window by dividing the LFP by the HFP and means for calculating an average acoustic low/high ratio (ALHRₐᵥₑ). With the method, the ALHRₐᵥₑ can serve as an index for determining a person's nasality.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of a method for measureing nasality in accordance with the present invention; and

FIG. 2 is a table of average acoustic low/high ratios of different test subjects at different cut frequencies using the method in FIG. 1.

### DETAILED DESCRIPTION OF PREFERRED EMBODIMENT

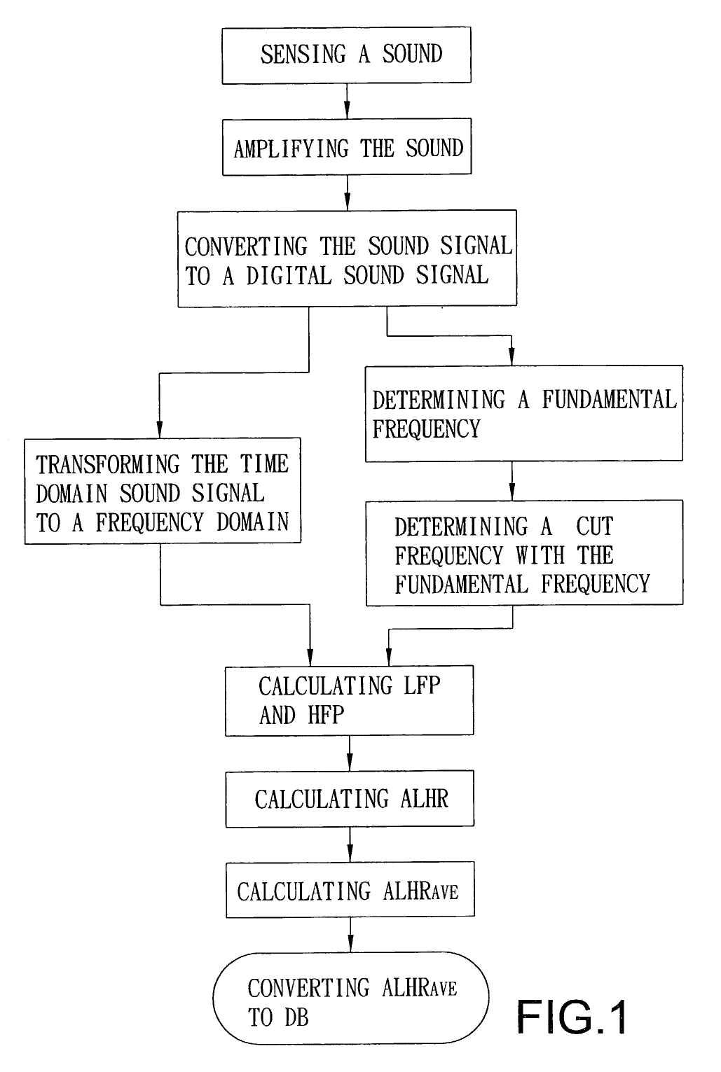

With reference to FIG. 1, a method for detecting nasality in accordance with the present invention comprises the following steps:

Sensing a sound with a high sensitivity microphone. The test subject enunciates a nasal consonant-vowel sound such as [mo], [mer] or [mir] for several seconds, preferably at least five seconds. The microphone senses the sound enunciated by the test subject. Wherein, the frequency response of the microphone is stable between 20 Hz and 22 kHz. In addition, a background noise signal generated for 0.5 to 1 second is always sensed prior to a formal test to determine a start time for the enunciated sound signal. The start time of the enunciated sound signal is the time when the root mean square of the sound signal is two times larger than the root mean square of the background noise signal.

Amplifying the received sound signal. The microphone sends the sensed signal to an amplifier to amplify the signal, and the signal is then transferred to a computer.

Converting the analog sound signal to a digital sound signal.

The sound signal sent from the microphone is captured by the sound sampling device of the computer and the samping rate should be greater than 16 kHz to ensure the sensitivity at high pitch area of the sound signal. Transforming the digital time domain sound signal to a frequency domain by means of a Fast Fourier Transformation (FFT). Wherein, a 3-second sound signal starting since 0.5 second from the beginning of the sound signal is analyzed. The analyzed sound signal is divided into several calculation windows for FFT, and the frequency resolution should be less than 10 Hz to make ALHR independent of the change of window sizes. For examples, to our experience, the window sizes should be more than 2048 calculation points in case of the sound sampling rate of 22 kHz.

Determining a cut frequency (f_{cut}) to divide the frequency domain signal into a low frequency band (from 65 Hz to f_{cut}) and a high frequency band (from f_{cut} to 8000 Hz) is essential. Wherein, the cut frequency is determined by square root times of the fundamental frequency, which is a rate at which vocal folds are oscillating during phonation, i.e. \sqrt{2×3} (2.45), \sqrt{3×4} (3.46), \sqrt{4×5} (4.47) or \sqrt{5×6} (5.48) times of the fundamental frequency. The fundamental frequency is determined by the autocorrelation method of the sampled sound signal.

Calculating low frequency power (LFP) and high frequency power (HFP) of each window. Wherein,

$$LFP = {\sum }_{i = 65}^{fcut} Pi ; HFP = {\sum }_{i = fcut}^{8000} Pi$$

Pi is the power at i Hz.

Calculating an acoustic low/high ratio (ALHR) by dividing LFP by HFP, i.e.

ALHR=LFP/HFP

Calculating an average acoustic low/high ratio (ALHRₐᵥₑ) by averaging the ALHR of the all calculation windows, i.e.

$${ALHR}_{ave} = ( {\sum }_{i = 0}^{3 sec} Ri ) / n$$

Wherein, Ri is the ALHR of the window at i seconds, and n is the quantity of the window. The ALHRₐᵥₑ can also be converted to decibels (dB) with the following equation:

ALHRₐᵥₑ(dB)=log₁₀(ALHR)×10

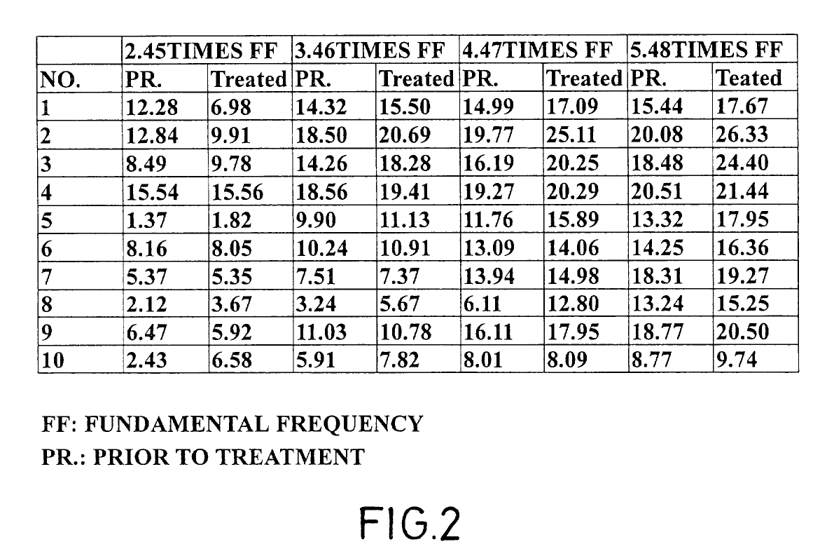

With the ALHRₐᵥₑ, the nasality of the test subject is observed. With reference to FIG. 2, the ALHRₐᵥₑ of different test subjects is measured prior to treatment and after being treated., The treatment has the effects to decongest nasal mucosa and therefore the nasal obstruction is relieved and the nasality is greater after treatment. All of the ALHRₐᵥₑ increase with different cut frequencies after the test subject has an appropriate treatment to his or her nose. The test results show that ALHRₐᵥₑ is proportional to the smoothness of the nasal cavity of the test subject, and the ALHRₐᵥₑ increases when the nasal cavity of the test subject becomes smooth. ALHRₐᵥₑ is an index for determining the nasality of a patient. Because only a microphone and a computer are needed to implement the method, performing the method is convenient, and the cost for the equipment is reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for measuring nasality comprising steps of:
sensing a sound enunciated for several seconds;
amplifying the sensed sound signal;
converting the amplified sound signal to a digital sound signal;
transforming the digital time domain sound signal to a frequency domain with a Fast Fourier Transformation (FFT), wherein, the time domain sound signal is divided into several calculation windows for FFT, and each window has multiple calculation points;
determining a cut frequency (f_{cut}) to divide the sound frequency spectrum into a low frequency band and a high frequency band;
calculating a low frequency power (LFP) and a high frequency power (HFP) of each window, wherein the LFP is a sum of the power at frequencies below the cut frequency and LFP is a sum of the power at frequencies above the cut frequency;
calculating an acoustic low/high ratio (ALHR) of each window by dividing LFP by HFP; and
calculating an average acoustic low/high ratio (ALHRₐᵥₑ) by averaging the ALHR of all of the windows.

2. The method as claimed in claim 1, wherein the sampling rate of the sound signal should be greater than 16 kHz, and the-frequency resolution for Fast Fourire Transformation should be less than 10 Hz.

3. The method as claimed in claim 1, wherein the sound is generated by a test subject enunciating a nasal consonant-vowel tone for several seconds.

4. The method as claimed in claim 1 further comprising generating and sensing a background noise prior to sensing the sound to determine a start time of the sound signal.

5. The method as claimed in claim 4, wherein the start of the sound signal is when the root mean square of the sound signal is two times larger than the root mean square of the background noise signal.

6. The method as claimed in claim 5, wherein the sound signal is analyzed from 0.5 second from the start of the sound signal to the 3.5 seconds from the start of the sound signal.

7. The method as claimed in claim 1, wherein the low frequency band is from 65 Hz to f_{cut}; and
the high frequency band is from f_{cut} to 8000 Hz.

8. The method as claimed in claim 7, wherein the cut frequency is determined by square root times of a fundamental frequency.

9. The method as claimed in claim 1, wherein the step of sensing the sound signal uses a high sensitivity microphone.
